(19) United States
(12) Patent Application Publication
(10) Pub. No.: US 2018/0145315 A1
(43) Pub. Date: May 24, 2018

(54) HIGH CAPACITY LITHIUM RICH CATHODE MATERIAL AND METHOD OF PRODUCING THE SAME

(71) Applicant: Hong Kong Applied Science and Technology Research Institute Co., Ltd., New Territories (HK)

(72) Inventors: Yingkai Jiang, Shenzhen City (CN); Bin Wang, New Territories (CN); Pau Yee Lim, Hong Kong (HK); Man On Fu, Lam Tin (HK)

(21) Appl. No.: 15/874,456

(22) Filed: Jan. 18, 2018

Related U.S. Application Data
(62) Division of application No. 14/461,440, filed on Aug. 18, 2014.

(51) Int. Cl. H01M 4/36; H01M 4/1391; H01M 4/131; C01G 53/00; H01M 4/505; H01M 4/62; H01M 4/04; H01M 4/525; H01M 10/052; H01M 4/02

(52) U.S. Cl. CPC H01M 4/364; H01M 4/1391; H01M 4/131; C01G 53/44; H01M 4/505; H01M 2004/021; C01P 2006/40; H01M 4/0471; H01M 4/525; C01P 2004/03; H01M 10/052; H01M 4/62

(57) ABSTRACT

A composite material for a battery electrode and a method of producing thereof have been disclosed. In particular, the composite material is used as a cathode for lithium ion batteries. The cathode material is a lithium-rich cathode material with high specific capacity, high capacity retention rate and high lithium ion diffusion. The cathode material is made by a plurality of clusters, in which each of the clusters comprises metallic nano-platelets arranged in a stratified array.

### CROSS-REFERENCE TO RELATED APPLICATIONS

The present application is a division of U.S. patent application Ser. No. 14/461,440 filed Aug. 18, 2014 and entitled “HIGH CAPACITY LITHIUM RICH CATHODE MATERIAL AND METHOD OF PRODUCING THE SAME,” the disclosure of which is incorporated by reference herein in its entirety.

### FIELD OF INVENTION

The present invention relates to a composite material for a battery electrode and a method of producing thereof. In particular, the composite material is used as a cathode for lithium ion batteries.

### BACKGROUND OF INVENTION

Lithium ion batteries are used as the power sources in different portable equipment, such as smartphones and notebook computers, because of high energy density compared to other rechargeable cells including Ni—Cd and NiMH cells.

Within every lithium ion batteries is a positive electrode (cathode), a negative electrode (anode) and an electrolyte between the cathode and the anode. Conventionally, LiCoO₂ is used as the cathode and graphite is used as the anode. As lithium ion batteries discharge, the lithium ions are moved from the anode to the cathode through the electrolyte.

### SUMMARY OF INVENTION

In the light of the foregoing background, it is an object of the present invention to provide an alternate composite material to be used as a cathode (cathode material) for lithium ion batteries.

Accordingly, the present invention, in one aspect, is a composite material including a plurality of clusters, wherein each of the clusters includes metallic nano-platelets arranged in a stratified array.

In one exemplary embodiment, each of the metallic nano-platelets includes lithium and at least two metals selected from the group consisting of manganese, nickel, cobalt, iron, magnesium and aluminum.

In another embodiment, the composite material is a lithium cathode material which has a first specific capacity of 150-250 mAh/g at 0.5 C.

In yet another embodiment, the lithium cathode material retains at least 80% of the first specific capacity at 0.5 C after 100 charge and discharge cycles.

In another aspect, the present invention is a composite material formed by a process including the steps of a) providing precursors, wherein each of the precursors includes a mixture of polyelectrolyte and metal oxide; b) heating the precursors with at least one lithium salt at a predetermined condition, wherein the polyelectrolyte and the metal oxide are attached together such that the precursors are in a form of nano-flakes or nano-rods clusters.

In one embodiment, the metal oxide includes at least two metals selected from the group consisting of manganese, nickel, cobalt, iron, magnesium and aluminum.

In another embodiment, the polyelectrolyte is cationic and is selected from the group consisting of poly(diallyldimethylammonium chloride), poly(acrylamide-co-diallyldimethylammonium chloride) and poly [bis (2-chloroethyl) ether-alt-1,3-bis [3-(dimethylamino)propyl] urea.

In yet another embodiment, the precursors are provided by the steps of a) co-precipitating a metal hydroxide precipitate by using a metal salts solution and a precipitating agent; b) forming a suspension solution including a mixture of the metal hydroxide precipitate and the polyelectrolyte; c) hydrothermal treating the suspension solution at a predetermined temperature for a predetermined period of time to form the precursors, wherein the metal salts solution includes at least two metal salts selected from the group consisting of manganese, nickel, cobalt, iron, magnesium and aluminum. The metal hydroxide precipitate includes the metals in the metal salts solution. And the polyelectrolyte and the metal hydroxide precipitate are in opposite charges, wherein the polyelectrolyte is selected to provide charge attraction for association with the metal hydroxide precipitate but steric hindrance to orient the metal hydroxide precipitate in a predetermined configuration.

In yet another aspect, a method for producing composite material is also disclosed. The method includes the steps of a) providing precursors, wherein each of the precursors includes a mixture of polyelectrolyte and metal oxide; b) heating the precursors with at least one lithium salt at a predetermined condition, wherein the polyelectrolyte and the metal oxide are attached together such that the precursors are in a form of nano-flakes or nano-rods clusters.

There are many advantages to the present invention. First, the cathode material of the present invention shortens lithium-ion diffusion path and enhances/maximizes lithiation. The cathode material of the present invention also enhances electrolyte diffusion in micro-scale and provides stable structure during lithium-ion diffusion.

Other advantages of the present invention are that the specific capacity (mAh/g) and the specific capacity retention rate after a number of charge and discharge cycles are enhanced.

### BRIEF DESCRIPTION OF THE DRAWINGS

For a more complete understanding of the present invention, reference is made to the following detailed description and accompanying drawings, in which:

FIG. 1 is a flowchart illustrating a process of fabricating a lithium rich cathode material with stratified nano-platelets cluster structure according to one embodiment of the present invention;

FIG. 2 is a schematic diagram illustrating the suspension solution according to the one embodiment of the present invention;

FIG. 3 is a schematic diagram illustrating the precursor according to the one embodiment of the present invention;

FIG. 4 is a schematic diagram illustrating the cathode material according to the one embodiment of the present invention;

FIG. 5 is a SEM image of the precursor of Experimental Example 1;

FIG. 6 is a SEM image of the cluster of Experimental Example 1;

FIG. 7 is a SEM image of the surface of the cluster which shows nano-platelets of Experimental Example 1;

FIG. 8 is a chart illustrating the performance of the cathode material obtained in Experimental Example 1 in a C-rate test; and

FIG. 9 is a chart illustrating the cycle performance at 0.5 C of the cathode material obtained in Experimental Example 1.

### DETAILED DESCRIPTION

As used herein and in the claims, “comprising” means including the following elements but not excluding others.

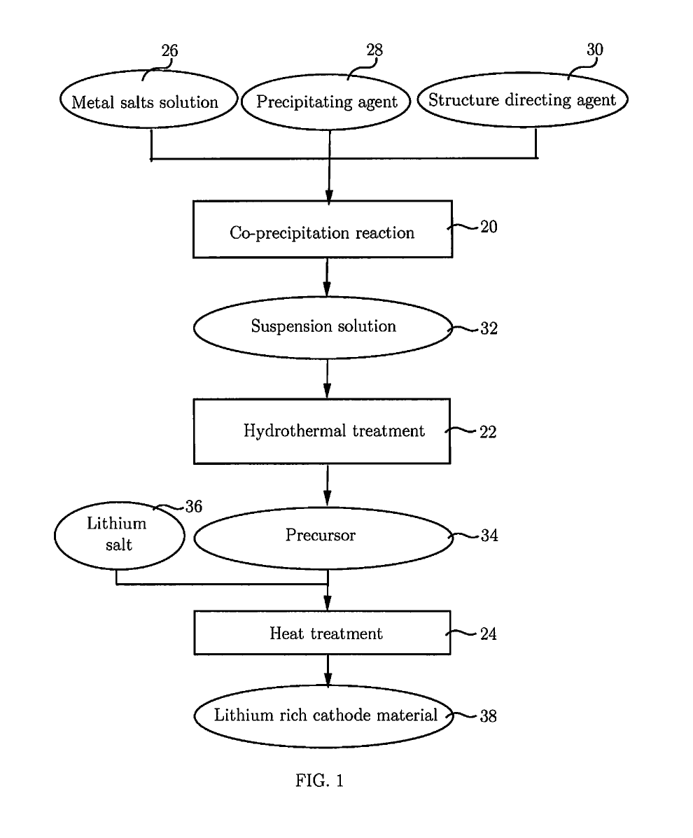

Referring to FIG. 1, a method for producing a cathode material, particularly a lithium rich cathode material, for lithium ion batteries of the present invention includes three steps, namely a co-precipitation step 20, a hydrothermal treatment step 22 and a heat treatment step 24.

The co-precipitation step 20 is a step of mixing metal salts solution 26, precipitating agent 28 and structure directing agent 30 to produce a suspension solution 32.

The hydrothermal treatment step 22 is a step of hydrothermal treating the suspension solution 32 to produce precursors 34.

The heat treatment step 24 is a step of heat treating the precursors 34 with a lithium salt 36 to cause a reaction to produce the lithium rich cathode material 38.

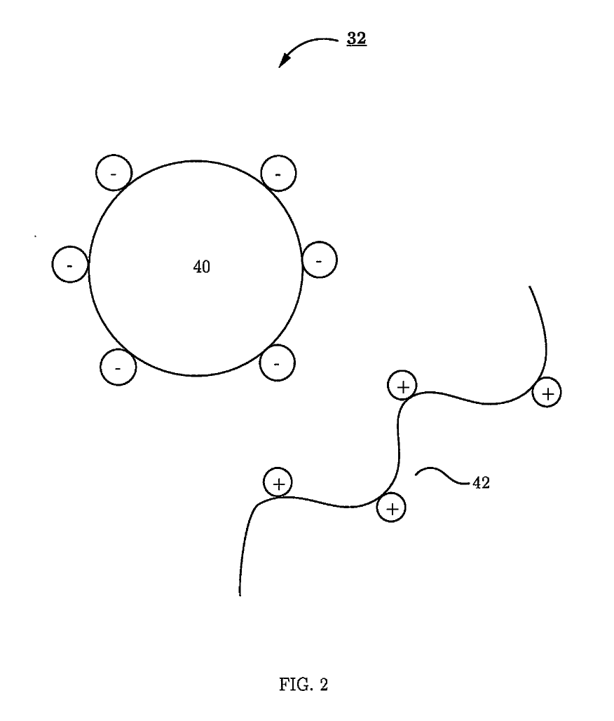

Now refers to the co-precipitation step 20. The suspension solution 32 is produced by mixing metal salts solution 26, precipitating agent 28 and structure directing agent 30 at a temperature range of 50° C.-100° C. and at a pH range of 8-12. As shown in FIG. 2, the suspension solution 32 includes anionic metal hydroxide precipitate 40 and structure directing agent 30, which includes cationic polyelectrolyte 42 in an aqueous solution. The size of each of the metal hydroxide precipitate 40 is in a range of 1-20 μm. The metal hydroxide precipitate 40 is produced by a reaction between the metal salts in the metal salts solution 26 and the precipitating agent 28. The metal salts used are manganese sulfates, nickel sulfates and cobalt sulfates while sodium hydroxide is used as the precipitating agent 28. The reaction pathway of such can be represented by the following equation:

Mⁿ+nOH⁻→M(OH)ₙ (1)

Where M is a combination of Mn²+, Ni²⁺, Co²⁺ ions and n=2. As shown in the chemical equation equation (1) above, the metal hydroxide precipitate 40 are a manganese-nickel-cobalt hydroxide. Although three metal salts are used in this embodiment (as a result M is a combination of three metals), two or more metal salts can be used in other embodiments (which results that M is a combination of two or more metal ions). The variations of metal salts are described in paragraph [0050] below.

As stated above, the structure directing agent 30 in the suspension solution 32 is cationic polyelectrolyte 42, which is added together when the metal salts solution 26 and the precipitating agent 28 are brought together. The cationic polyelectrolyte 42 is selected such that the cationic polyelectrolyte 42 provide charge attraction to the metal hydroxide precipitate 40 for association thereon but steric hindrance to orient the metal hydroxide precipitate 40 in particular configuration when such are attached to the polyelectrolyte 42 during crystallization in the hydrothermal treatment step 22. The metal hydroxide precipitate 40 are only aligned sideways to the polyelectrolyte 42 when they are attached. The cationic polyelectrolyte 42 used is poly(diallyldimethylammonium chloride).

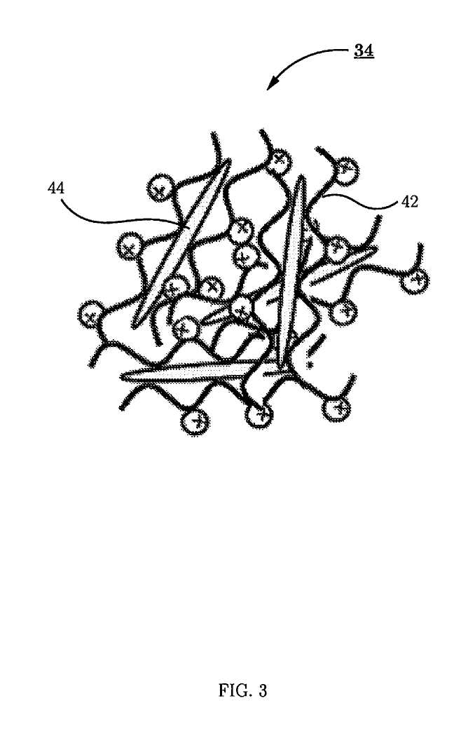

In the hydrothermal treatment step 22, the precursors 34 are crystallized by hydrothermal treating the suspension solution 32 in an autoclave at 100° C.-250° C. for 2-72 hours in water at a hydrothermal pressure of 0.1-0.3 MPa. During crystallization, due to the opposite charges between the metal hydroxide precipitate 40 and the polyelectrolyte 42, and the steric hindrance effect acted onto the metal hydroxide precipitate 40 by the polyelectrolyte 42, the polyelectrolyte 42 attracts the metal hydroxide precipitate 40 together in a way that some channels are formed among the metal hydroxide precipitate 40 due to the spatial occupation of the polyelectrolyte 42 among the metal hydroxide precipitate 40. As such, the metal hydroxide precipitate 40 and the polyelectrolyte 42 are attracted together to form nano-flakes and/or nano-rods clusters. The metal hydroxide precipitate 40 in the clusters is further oxidized to form metal oxide 44 (as shown in FIG. 3), where the metal is a combination of manganese, nickel and cobalt (Therefore, the metal oxide 44 is manganese-nickel-cobalt oxide). Thereby, the precursors 34 are formed. FIG. 3 shows one of the clusters of the precursors 34, in which the metal oxide 44 is attached to the sideways of the polyelectrolyte 42 and channels are formed between the metal oxide 44. The pore size and pore volume of the precursors 34 formed in the hydrothermal treatment step 22 are 1-50 nm and 0.01-0.5 cm³/g respectively. The size of the clusters of the precursors 34 is 1-5 μm while the thickness and the length of the nano-flakes or nano-rods are in the range of 1-50 nm and 50-300 nm respectively.

Subsequently, the cathode material 38 is formed by heat treating the precursors 34 with the present of the lithium salt 36 at a temperature in the range of 500° C.-1000° C. for 2-72 hours in air in the heat treatment step 24. The lithium salt 36 used is lithium hydroxide. During the heat treatment, the polyelectrolyte 42 in the precursors 34 are decomposed while the metal oxide 44 is further reacted with the lithium salt 36 to form the cathode material 38 which is a lithium metal oxide composite, which is a manganese-nickel-cobalt-lithium oxide. The channels formed by the polyelectrolyte 42 between the metal oxide 44 in the precursors 34 become the lithium ion channels between the lithium metal oxide composite in the cathode material 38 after the heat treatment step 24. The cathode material 38 can be represented by the following chemical formula: Li[LiₓMn_{y}Ni_{z} Co_{(1-x-y-z)}]O₂, wherein 0.1≤x≤0.3, 0.4≤y≤0.8, 0.1≤z≤0.4 and 1-x-y-z≥0.

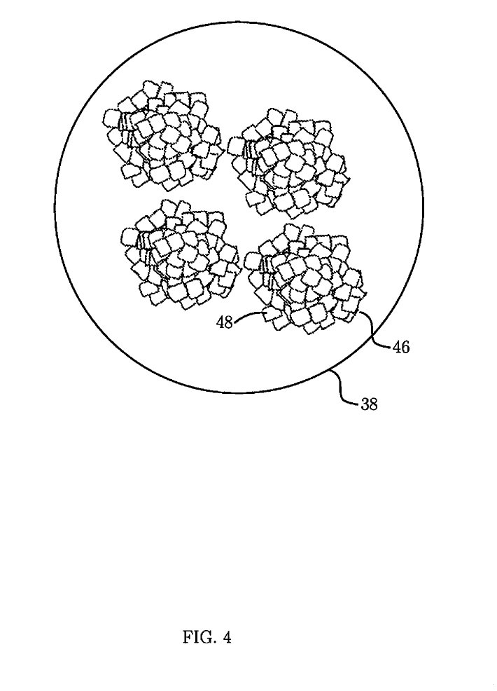

The cathode material 38 of the present invention is shown in FIG. 4. The cathode material 38 is made up of clusters 46, in which each of the clusters 46 is formed by a group of metallic nano-platelets 48 arranged in a stratified array. The cathode material 38 is a stabilized structure with the pore size and pore volume of 10-100 nm and 0.01-0.2 cm³/g respectively. The size of each of the clusters 46 is in a range of 5-25 μm. The thickness and the diameter of the nano-platelets 48 are 1-50 nm and 50-200 nm respectively.

Each of the metallic nano-platelets 48 is the lithium metal oxide composite, which is a manganese-nickel-cobalt-lithium oxide. The lithium metal oxide composite can be represented by the following chemical formula Li[LiₓMn_{y}Ni_{z} Co_{(1-x-y-z)}]O₂ wherein 0.1≤x≤0.3, 0.4≤y≤0.8, 0.1≤z≤0.4 and 1-x-y-z≥0. The structure of the stratified nano-platelets 48 cluster provides shortened lithium-ion diffusion channel. It also enhances/maximizes lithiation and electrolyte diffusion. Particularly, the high specific surface area of the nano-platelets 48 shortens the lithium-ion diffusion path and enhances/maximizes the lithiation. The stratified array configuration of the nano-platelets 48 stabilizes the structure of the cathode material 38 during lithium-ion diffusion. Further, the clustery structure enhances electrolyte diffusion in micro-scale. It is noted that the combination of metals included in the lithium metal oxide composite of the metallic nano-platelets 48 are lithium and the metals of the metal salts used. Therefore, although in this embodiment, the lithium metal oxide composite of the metallic nano-platelets 48 is manganese-nickel-cobalt-lithium oxide, the lithium metal oxide composite of the metallic nano-platelets 48 in another embodiment can be different. The lithium metal oxide composite can be a metal oxide with a combination of at least two metals with lithium, which the at least two metals in the lithium metal oxide composite is based on the metal salts used in the co-precipitation step 20. The variations of metal salts are described in paragraph [0050] below.

Due to the aforesaid enhancements, the specific capacity (mAh/g) of the cathode material 38 at discharge capacities of 0.5 C and 2 C are in a range of 150-250 mAh/g and 120-180 mAh/g respectively. Furthermore, the specific capacity retention rate is high. The cathode material 38 of the present invention retains at least 80% of the specific capacity at discharge capacity of 0.5 C after 100 charge and discharge cycles.

### EXAMPLE

Hereinafter, a specific example of the present invention will be described by way of Experimental Example. However, the present invention is not limited to this.

### Experimental Example 1

In a typical synthesis, 0.2 M metal salt solution is prepared by dissolving manganese and nickel salt in DI water. 2 M precipitating agent solution is prepared by dissolving NaOH and NH₃ in DI H₂O. A concentration of 5% solution comprises structure directing agent is prepared. The metal salt solution and precipitation agent solution is pump into structure directing agent solution with pH control in the range of 8-11. Afterwards, the suspension is transferred into Teflon-lined stainless steel autoclave and placed in the oven for hydrothermal treatment at 150° C. After natural cooling of the hydrothermal reactor, the Mn—Ni—O composite precursors are collected and dried.

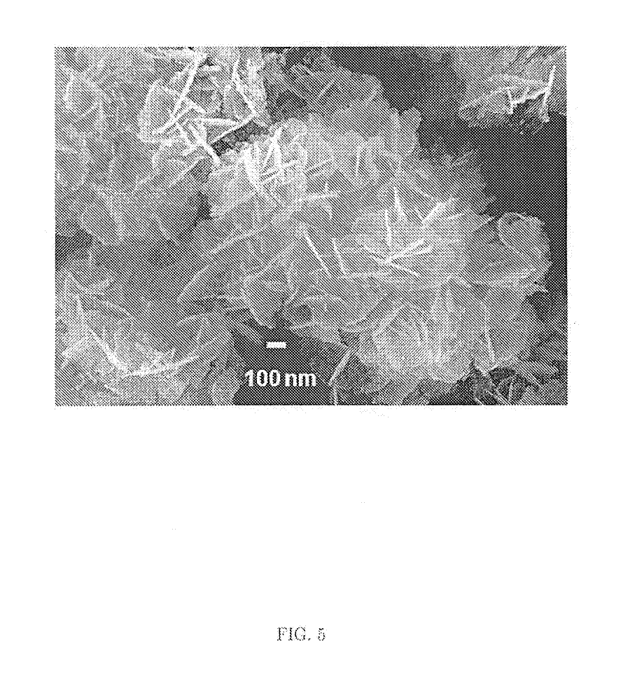

A scanning electron microscope (SEM) image of the precursors 34 is shown in FIG. 5. The precursors 34 are clusters of nano-flakes and/or nano-rods. The size of the clusters is about 2 μm, whereas the length and the thickness of the nano-flakes or nano-rods are about 300 nm and 20 nm respectively.

For lithiation by heat treatment, the mole ratio of LiOH:Metal=1.25 is weighted and mixed homogeneously. The mixture is placed in muffle furnace for solid state reaction at above 600° C. for 12 hrs with a heating rate of 2.5° C./min. The as-obtained product is lithium rich cathode material 38 and passed 400 mesh sieves before electrochemical test in coin cell.

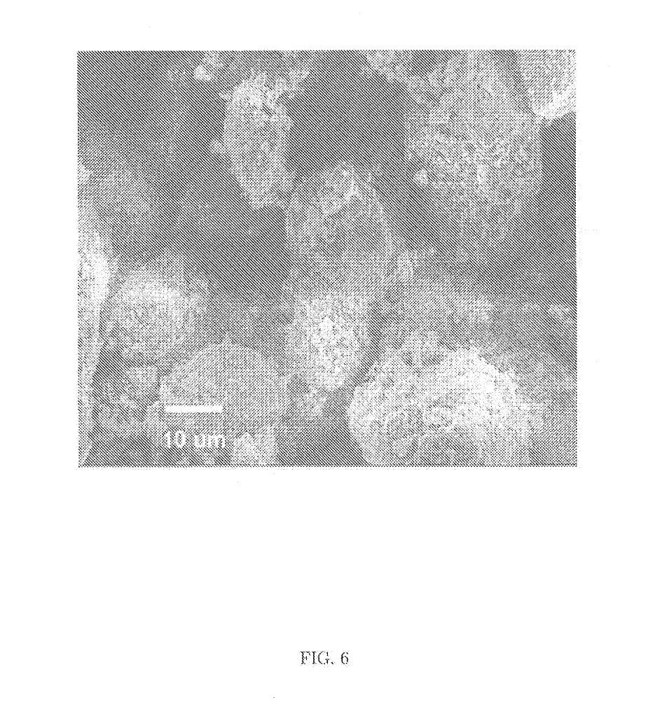

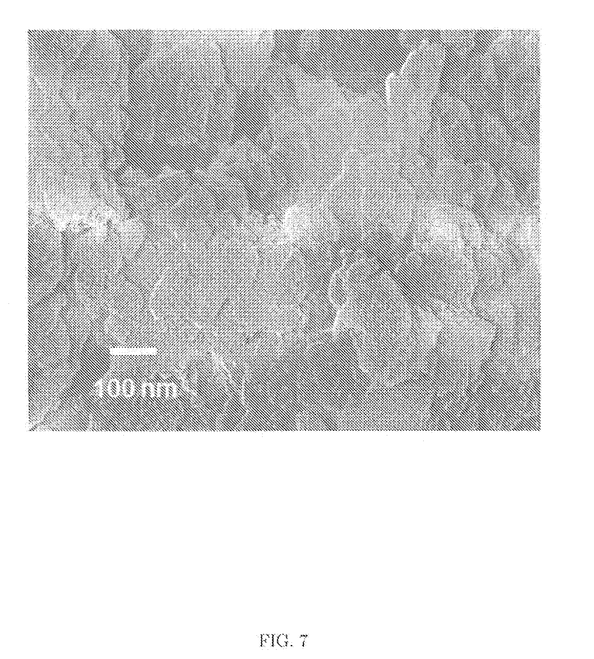

SEM images of the cathode material 38 obtained are shown in FIG. 6 and FIG. 7. As shown in FIG. 6, the cathode material 38 is formed by a plurality of clusters 46. The size of each of the clusters 46 is about 20 μm. FIG. 7 is an image of the surface of one of the clusters 46 as shown in FIG. 6. The surface of the clusters 46 contains a plurality of metallic nano-platelets 48 arranged in stratified array. The size and the thickness of the nano-platelets 48 is about 100 nm and 10 nm respectively.

The electrodes were prepared by mixing 94 w.t. % lithium rich cathode material with 3 w.t. % polyvinylidene fluoride (PVDF) and 3 w.t. % carbon black. N-methyl-2-pyrrolidinone (NMP) is used as solvent to form slurry with solid content of 50 wt. %. The slurry is uniformly spread on the Al foil which is used as current collector. After drying, the electrode is cut into wafers for coin cells assembly. CR2025 coin cells are assembly in an Argon-filled glove box using lithium foil as counter electrode and 1 M LiPF₄ in EC/EMC/DMC as electrolyte. The coin cells are evaluated at 0.1 C-0.1 C for first cycle charge-discharge test, and followed by 0.5 C-0.5 C for the rest cycles in the voltage range of 2.0-4.8V. The C-rate test is performed at 0.2 C charge and different C-rate discharge (e.g. 0.2 C, 0.5 C, 1.0 C and 2.0 C) at room temperature.

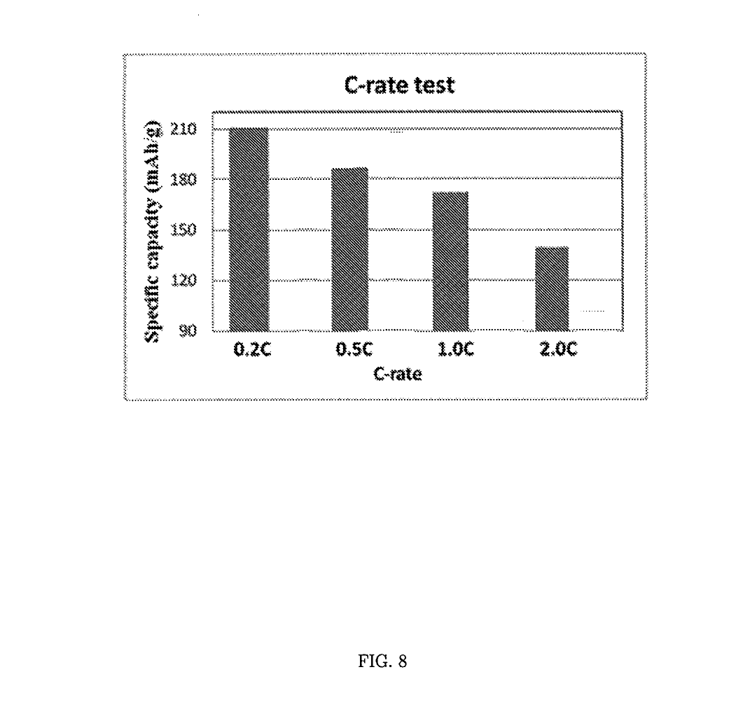

FIG. 8 illustrates a chart of the obtained cathode material 38 in Experimental Example 1 in a C-rate test. As shown in the chart, the specific capacities (mAh/g) of the obtained cathode material 38 at different C-rate discharges are high. The different C-rate discharges are shown in the table below:

TABLE 1

| | Specific capacity of the |
|---|---|
| | obtained cathode material obtained in |
| C-rate discharges | Experimental Example 1 |
| 0.2 C | about 210 mAh/g |
| 0.5 C | about 190 mAh/g |
| 1.0 C | about 170 mAh/g |
| 2.0 C | about 140 mAh/g |

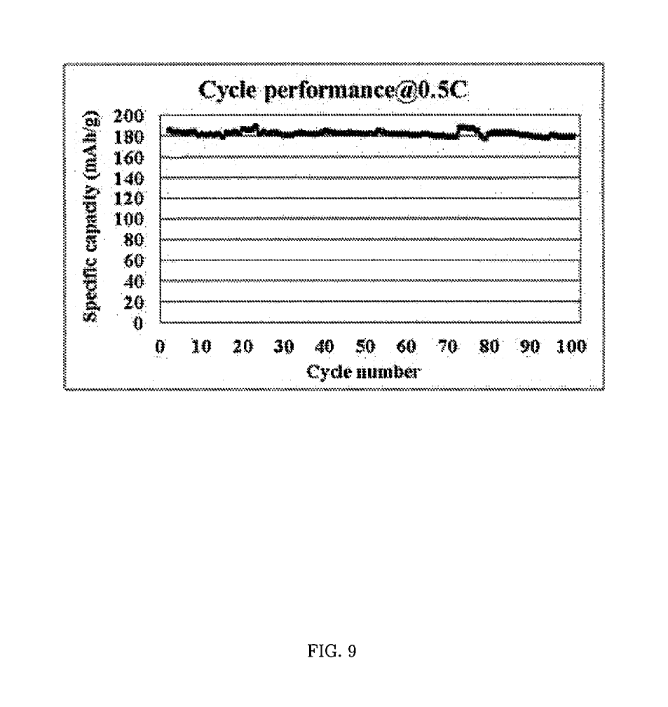

Cycle performance at 0.5 C of the cathode material 38 obtained is also tested. FIG. 9 shows that the specific capacity retention rate of the cathode material 38 obtained is 97% after 100 charge and discharge cycles at 0.5 C.

It will thus be seen that the objects set forth above, among those elucidated in, or made apparent from, the preceding description, are efficiently attained and, since certain changes may be made in the above construction and/or method without departing from the scope of the invention, it is intended that all matter contained in the above description or shown in the accompanying drawing figures shall be interpreted as illustrative only and not in a limiting sense.

The following claims should not be read as limited to the described order or elements unless stated to that effect.

For example, in the co-precipitation step 20, the at least two metal salts used in the metal salts solution 26 are further selected from the group consisting of manganese sulfates, nickel sulfates, cobalt sulfates, manganese nitrates, manganese acetates, manganese chlorides, nickel nitrates, nickel acetates, nickel chlorides, cobalt nitrates, cobalt acetates, cobalt chlorides, aluminum sulfates, aluminum nitrates, aluminum acetates and aluminum chlorides. The precipitating agent 28 is selected from the group consisting of metal hydroxides, metal carbonates and ammonium salts. In particular, the precipitating agent 28 is further selected from the group consisting of sodium hydroxide, sodium carbonates and ammonium bicarbonate. At least two metal salts are used and more than one precipitating agent 28 can be used.

The structure directing agent 30 used is polyquaternium. In particular, the structure directing agent 30 is selected from the group consisting of

1. poly(diallyldimethylammonium chloride);

2. poly(acrylamide-co-diallyldimethylammonium chloride); and

3. poly[bis(2-chloroethyl) ether-alt-1,3-bis[3-(dimethylamino)propyl]urea.

More than one structure directing agent 30 can be used.

Furthermore, the structure directing agent 30 can be added at the same time as or or before or after the metal salts solution 26 and precipitating agent 28 is mixed.

For example, in the heat treatment step 24, the lithium salt 36 used is selected from the group consisting of lithium hydroxide, lithium nitrate, lithium sulfate, lithium acetate and lithium chloride. More than one lithium salt 36 can be used. Also in the heat treatment step 24, the precursors 34 with the present of the lithium salt 36 can be heat treated in the present of oxygen. Preferably, the oxygen content of 20%-100% is used.

What is claimed is:

1. A composite material comprising:
a plurality of metallic nano-platelets that are arranged in a stratified array, each of the metallic nano-platelets having a thickness of 1-50 nm and a diameter of 50-200 nm;
a plurality of pores having a diameter of 10-100 nm between the metallic nano-platelets; and
a plurality of clusters, each having a size of 5-25 μm that are formed by the metallic nano-platelets,
wherein, when the composite material is used as a cathode in a lithium-ion battery, the stratified array of the nano-platelets enhances lithiation and shortens a diffusion path of lithium ions such that a specific capacity of the composite material is at least 210 mAh/g at 0.2 C.

2. The composite material of claim 1, wherein the pores in the clusters have a volume of 0.01-0.2 cm³/g.

3. The composite material of claim 1, wherein the metallic nano-platelets are a manganese-nickel-cobalt-lithium oxide.

4. The composite material of claim 1, wherein the stratified array of the nano-platelets is adapted such that the diffusion path of the lithium ions is shortened and a structure of the composite material is kept stable during lithium-ion diffusion.

5. The composite material of claim 1, wherein the formula of the composite material is:
Li[LiₓMn_{y}Ni_{z}Co_{(1-x-y-z)}]O₂
wherein 0.1≤x≤0.3, 0.4≤y≤0.8, 0.1≤z≤0.4, and 1-x-y-z≥0.

6. The composite material of claim 1, wherein each of the metallic nano-platelets comprises lithium and at least two metals selected from a group consisting of manganese, nickel, cobalt, iron, magnesium, and aluminum.

7. The composite material of claim 1, wherein the composite material is a lithium cathode material of the lithium ion battery that shortens the diffusion path of lithium ions to achieve a specific capacity of 150-250 mAh/g at 0.5 C, and retains at least 80% of the specific capacity at 0.5 C after 100 charge and discharge cycles.

8. A lithium cathode material for a lithium ion battery, the lithium cathode material comprising:
a plurality of metallic nano-platelets that are arranged in a stratified array, each of the metallic nano-platelets having a thickness of 1-50 nm and a diameter of 50-200 nm and wherein each of the metallic nano-platelets comprises lithium;
a plurality of pores having a diameter of 10-100 nm between the metallic nano-platelets; and
a plurality of clusters, each having a size of 5-25 μm that are formed by the metallic nano-platelets,
wherein the stratified array of the nano-platelets is adapted such that the lithium cathode material (1) has a specific capacity of at least 210 mAh/g at 0.2 C, (2) has a specific capacity of 150-250 mAh/g at 0.5 C, and (3) retains at least 80% of the specific capacity at 0.5 C after 100 charge and discharge cycles.

9. The lithium cathode material of claim 8, wherein the pores in the clusters have a volume of 0.01-0.2 cm³/g.

10. The lithium cathode material of claim 8, wherein the metallic nano-platelets are a manganese-nickel-cobalt-lithium oxide.

11. The lithium cathode material of claim 8, wherein the stratified array of the nano-platelets is adapted such that the structure of the lithium cathode material is kept stable during lithium-ion diffusion.

12. The lithium cathode material of claim 8, wherein the formula of the lithium cathode material is:
Li[LiₓMn_{y}Ni_{z}Co_{(1-x-y-z)}]O₂
wherein 0.1≤x≤0.3, 0.4≤y≤0.8, 0.1≤z≤0.4, and 1-x-y-z≥0.

13. The lithium cathode material of claim 8, wherein each of the metallic nano-platelets further comprises at least two metals selected from a group consisting of manganese, nickel, cobalt, iron, magnesium, and aluminum.

14. A composite material comprising:
a plurality of metallic nano-platelets that are arranged in a stratified array, each of the metallic nano-platelets having a thickness of 1-50 nm and a diameter of 5-200 nm;
a plurality of pores having a diameter of 10-100 nm between the metallic nano-platelets; and
a plurality of clusters each having a size of 5-25 μm that are formed by 100 or more of the metallic nano-platelets,
wherein the stratified array of the nano-platelets enhances lithiation in a lithium-ion battery and shortens a diffusion path of lithium ions to enhance a specific capacity of the composite material to at least 210 mAh/g at 0.2 C.
